(19) United States
(12) Patent Application Publication
(10) Pub. No.: US 2017/0240438 A1
(43) Pub. Date: Aug. 24, 2017

(54) LIQUID QUALITY DEVICE WITH WEIR

(71) Applicant: Advanced Drainage Systems, Inc., Hilliard, OH (US)

(72) Inventors: Joseph Andrew Babcanec, Powell, OH (US); Daniel J. Figola, Powell, OH (US); Corey M. Francis, Columbus, OH (US); Ronald R. Vitarelli, Marlborough, OH (US)

(21) Appl. No.: 15/049,617

(22) Filed: Feb. 22, 2016

(51) Int. Cl. C02F 1/38; B04C 5/12; B04C 5/081; B04C 5/14

(52) U.S. Cl. CPC C02F 1/38; B04C 5/14; B04C 5/12; B04C 5/081; C02F 2103/001

(57) ABSTRACT

An inventive apparatus induces a vortex in a liquid flow (e.g., storm-water runoff) to remove particulates from the liquid. The apparatus can be inserted into a tubular portion (e.g., a manhole) such that a sump region is located below the apparatus. The apparatus includes a base and a weir extending upwardly from the base. The base has a first region including a funnel shape with a sump inlet aperture. The base also has a second region including a sump outlet aperture and optionally a sump access aperture. The weir separates the first region from the second region.

### CROSS REFERENCE TO RELATED APPLICATIONS

[Not Applicable]

### BACKGROUND

Generally, this application relates to techniques for removing sediment, debris, pollutants, and/or total suspended solids (all or some of which can be herein referred to as “particulates”) from a liquid, such as storm-water runoff. In particular, this application discloses techniques for removing at least some particulates from storm-water runoff.

Water runoff management (e.g., water generated by a rainfall) may be a challenging issue for landowners or municipalities. Not only does the flow of water have to be managed in order to reduce the risk of flooding, but particulates in the water should also be reduced, because such particulates reach rivers, ponds, lakes, or the ocean. Therefore, improved techniques of reducing particulates in water runoff are desired.

### SUMMARY

According to certain inventive techniques, an apparatus induces a vortex in a liquid flow (e.g., storm-water runoff) to remove particulates from the liquid. The apparatus may be configured to be inserted into a tubular portion (e.g., a manhole) such that a sump region is located below the apparatus. The apparatus includes a base and a weir. The base includes a first region including a funnel shape with a sump inlet aperture. The base also includes a second region including a sump outlet aperture and optionally a sump access aperture. The base may be one integrated piece and may include a material such as polyethylene.

The weir extends upwardly from the base and separates (e.g., partially or completely separates) the first region from the second region. The weir may comprise a curvature along a horizontal dimension, and this curvature may be concave when viewed from the first region. The weir may have an aperture, which may have a rectangular shape. The weir may be a separate piece from the base. The base may have a groove that accepts the weir. The apparatus may also include a clean out riser extending upwardly from the sump access aperture.

According to certain inventive techniques, an apparatus for inducing a vortex in a liquid flow to remove particulates from the liquid includes a bottom plate, a tubular portion, and a liquid quality device. The tubular portion extends upwardly from the bottom plate and has an inlet and an outlet (which may be positioned in an inline or offline arrangement). The liquid quality device is located above the bottom plate. The liquid quality device extends horizontally across the tubular portion and defines a sump region between the liquid quality device and the bottom plate.

The liquid quality device includes a base and a weir. The base has a first region and a second region. The base may be formed from one integrated piece and may include a material such as polyethylene. The first region includes a funnel shape and a sump inlet aperture. The first region is arranged to receive a flow of the liquid from the inlet of the tubular portion. The second region comprising a sump outlet aperture and optionally a sump access aperture, wherein the second region is arranged to transfer a flow of the liquid to the outlet of the tubular portion. The apparatus may also have a clean out riser extending upwardly from the sump access aperture.

The weir extends upwardly from the base and separates (e.g., completely or partially separates) the first region from the second region. The weir may include a curvature along a horizontal dimension. The curvature may be concave when viewed from the first region. The weir may also have an aperture, which may be rectangular in shape. The weir and the base may be separate pieces. The base may have a groove arranged to accept the weir. The weir completely separates the first region from the second region.

### BRIEF DESCRIPTION OF SEVERAL VIEWS OF THE DRAWINGS

FIG. 1 illustrates a perspective view of liquid quality device, according to certain inventive techniques.

FIG. 2 illustrates an elevational view, partially cross-sectioned, of a liquid quality device in a manhole, according to certain inventive techniques.

FIG. 3 illustrates a top view of a liquid quality device in a manhole with an inline arrangement, according to certain inventive techniques.

FIG. 4 illustrates a top view of a liquid quality device in a manhole with an offline arrangement, according to certain inventive techniques.

FIG. 5A illustrates a sequence showing how fluid flows through a liquid quality device in a manhole, according to certain inventive techniques.

FIG. 5B illustrates a sequence showing how particulates are separated from a liquid by use of a liquid quality device in a manhole, according to certain inventive techniques.

FIG. 6A illustrates a perspective view of a liquid quality device, according to certain inventive techniques.

FIG. 6B illustrates a perspective and exploded view of a liquid quality device, according to certain inventive techniques.

FIG. 6C illustrates a top view of a liquid quality device, according to certain inventive techniques.

FIG. 6D illustrates an elevational view of a liquid quality device, according to certain inventive techniques.

FIG. 7 illustrates a liquid quality device, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

A liquid quality device may be used to reduce particulates in liquid runoff (e.g., storm-water runoff). Some liquid quality devices may be designed to treat a specific flow rate of liquid that occurs during the “first flush” of a rainfall event. Note, as used herein, a “rainfall event” or “event” includes the time while rain is actually falling and subsequent liquid runoff periods. The liquid in the first flush typically has more suspended particulates as compared with later parts of the flow. As the rainfall event continues, the flow rate at which liquid enters the liquid quality device will typically increase while the particulate load in the liquid typically decreases.

By inducing a vortex in the liquid with a liquid quality device, suspended particulates may accumulate on the outside of the vortex, thereby separating the liquid from the particulates. However, if the velocity of liquid flow is too great in the vortex, the accumulated particulates may be mixed back up into the liquid, thus reducing the effectiveness of the liquid quality device.

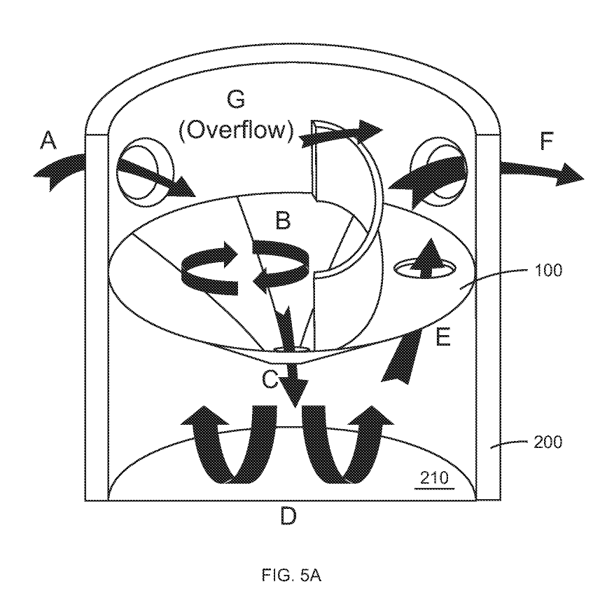

According to the techniques disclosed herein, an inventive liquid quality device may be better adapted to remove particulates at the lower flow rate (first flush) while allowing some of the liquid at higher flow rates (typically having fewer suspended particulates) to bypass treatment. By reducing the volume of flow induced into a vortex, the velocity of the vortex is also reduced, thereby reducing the amount of particulates that are mixed back up into the liquid. This technique may improve the effectiveness of the liquid quality device, and it will be described in greater detail below, and with particular reference to FIG. 5.

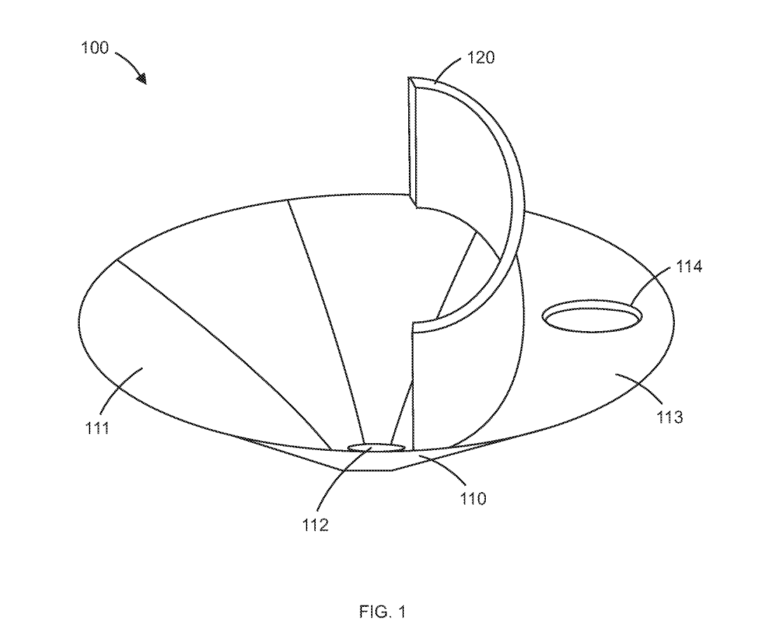

FIG. 1 illustrates a perspective view of a liquid quality device 100, according to certain inventive techniques. The liquid quality device 100 includes a base 110 and a weir 120. The base 110 may have a first region 111 and a second region 113, which may be separated by the weir 120. The base 110 may be one integrated piece, or formed from separate pieces (e.g., the first region 111, the second region 113, the vortex-inducing region, etc.) The base 110 and/or the weir 120 may include a material such as polyethylene or polypropylene. The base 110 and weir 120 may be one integrated piece or may be separate pieces.

The weir 120 may completely (or partially) separate the first region 111 from the second region 113. As can be seen, the weir 120 may have a curvature along a horizontal dimension, and this curvature may be concave when viewed from the first region 111. The curvature may be constant, or may have a curve with a varying radius as shown. For example, the depicted curvature has shorter radiuses at the edges and one or more longer radiuses in the center. Such a varying-radius design may facilitate the creation of a relatively smooth transition between the weir 120 and the walls of a tubular portion (e.g., a manhole) in which the liquid quality device 100 is inserted (the “tubular portion” is discussed below). Such a varying curvature may assist in reducing turbulence (which may negatively impact the efficiency of the liquid quality device 100 to remove particulates). Alternatively, there may be no curvature, or there may be convex curvature in the weir 120, as viewed from the first region 111.

The first region 111 may include a vortex-inducing region and a sump inlet aperture 112. A vortex-inducing region may include a funnel shape as depicted in FIG. 1. The funnel may be designed to increase the length of time that the flow remains in the funnel and thus in a vortex. That in conjunction with the decreasing radius helps to maximize particulate separation. The second region 113 may include a sump outlet aperture 114. The second region 113 may have a generally flat profile in the horizontal dimension.

The size of the apertures 112 and/or 114 may be determined by using the following equation:

Q=C_{d}A\sqrt{2}gh

Where Q=flow rate in cubic feet per second;
C_{d}=is the coefficient of discharge;
A=area of the aperture in square feet;
g=is the acceleration of gravity (32.2 ft./second²); and
h=the head in feet acting on the aperture.

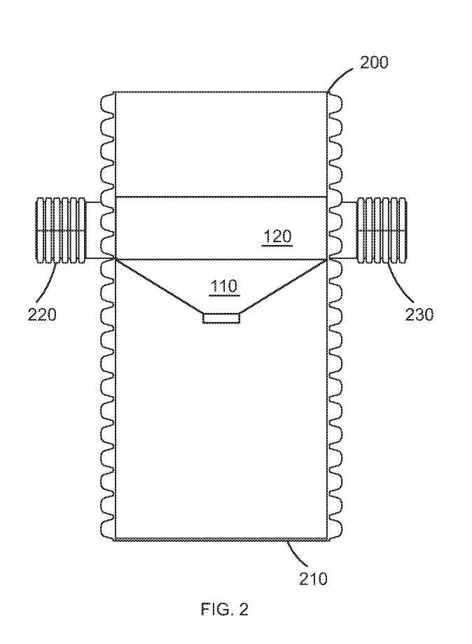

FIG. 2 illustrates an elevational view, partially cross-sectioned, of the liquid quality device 100 in a manhole 200, according to certain inventive techniques. The manhole 200 may include a bottom plate 210, an inlet 220, and an outlet 230. Any one of the bottom plate 210, the inlet 220, and/or the outlet 230 may be integrated into the body of the manhole 200, or they may be separate pieces that work or connect together to achieve the functions described herein.

The area between the liquid quality device 100 and the bottom plate 210 may be a sump. As will be described in further detail with respect to FIG. 5, liquid may flow into the manhole 200 through the inlet 220 and then into the sump, thereby passing through the liquid quality device 100. The liquid may exit the sump through the liquid quality device 100 and then exit the manhole 200 through the outlet 230.

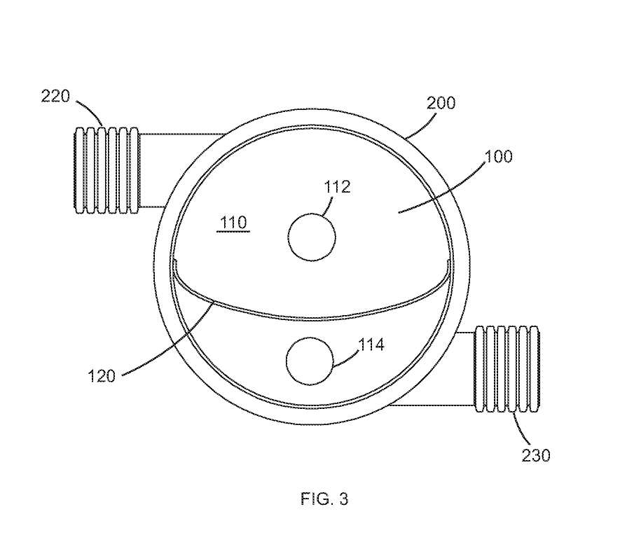

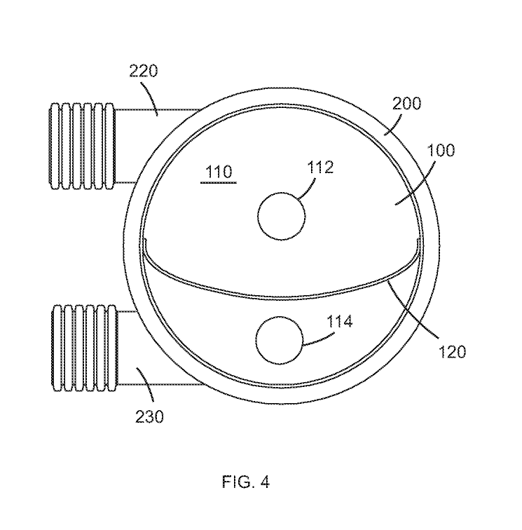

FIG. 3 illustrates a top view of the liquid quality device 100 in the manhole 200 with an inline arrangement of the inlet 220 and outlet 230, according to certain inventive techniques. In this arrangement, liquid enters the manhole 200 on one side through the inlet 220 and exits on the other side through the outlet 230. FIG. 4 illustrates an offline arrangement, where liquid enters and exits on the same side of the manhole 200. Other arrangements are possible, such as liquid entering and exiting the manhole 200 at right angles or oblique angles.

FIG. 5A illustrates a sequence showing how liquid flows through the liquid quality device 100 in the manhole 200, according to certain inventive techniques. At step A, liquid (which has suspended particulates) may enter the manhole 200 through the inlet 220. The liquid enters the manhole 200 at a location above the liquid quality device 100, and more particularly above the first region 111. During lower liquid volume flow (e.g., the first flush), the liquid is inhibited from flowing into the second region 113 by the weir 120.

At step B, the vortex-inducing region of the liquid quality device 100 together with the weir 120 induces the liquid into a vortex. At step C, the liquid passes through the liquid quality device 100 via sump inlet aperture 112 and into the sump (e.g., the area in the manhole 200 between the liquid quality device 100 and the bottom plate 210). At step D, the liquid propagates into the sump in the general direction shown by the arrows. Once the liquid passes into the sump, the vortex action may be reduced through detention time and energy losses. This may allow smaller pollutants that were not removed through the cyclonic action of the vortex in the funnel to settle out of the liquid.

At step E, the liquid exits the sump through the sump outlet aperture 113. The liquid is now above the second region 113, and the weir 120 inhibits the liquid from flowing back into the first region 111. At step F, the liquid exits the manhole 200 through outlet 230.

As the liquid level above the first region 111 rises, it will begin to, at step G, overtop the weir 120 and flow into an area above the second region 113. This liquid then exits the manhole 200 through the outlet 230, thereby bypassing the vortex-inducing steps. The overflowing liquid does not pass through the sump, and therefore treatment is bypassed. By allowing a portion of the increased liquid flow to avoid the treatment area in the sump, liquid flow velocities in the sump will be reduced. Consequently, there will be less of a problem with accumulated particulates being mixed back up with the liquid.

After the event, the accumulated particulates can be cleaned out through either the sump inlet aperture 112 or the sump outlet aperture 114. For example, a tube can be inserted through one or more of these apertures, and a vacuum can be applied through the tube.

FIG. 5B illustrates a sequence showing how particulates are separated from a liquid by use of the liquid quality device 100 (depicted without the weir 120 for clarity in the illustration) in the manhole 200, according to certain inventive techniques. As depicted, a vortex formed in the funnel region of the liquid quality device 100 pushes some of the relatively heavier particulates to the edges of the vortex (near the sides of the funnel) via a centrifugal force. These particles will then drop through the sump inlet aperture 112 into the sump, landing on the bottom plate 210.

Relatively lighter particulates will enter the sump and be carried upwards by the liquid flow. As these particulates are carried upward in the sump, the liquid flow loses velocity. This allows these relatively lighter particulates to fall out of the liquid flow and onto the bottom of the sump.

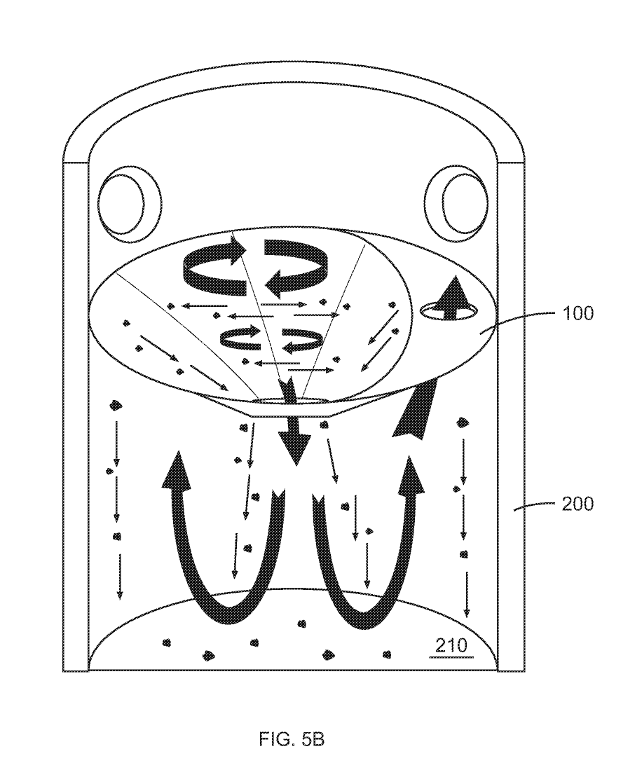

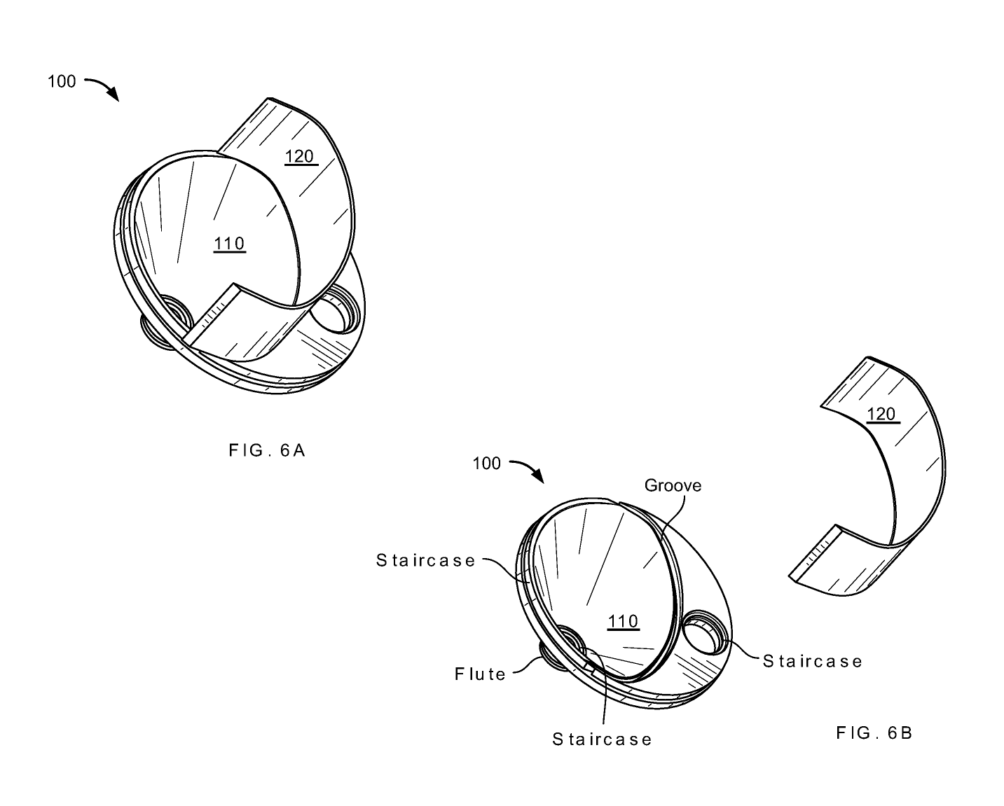

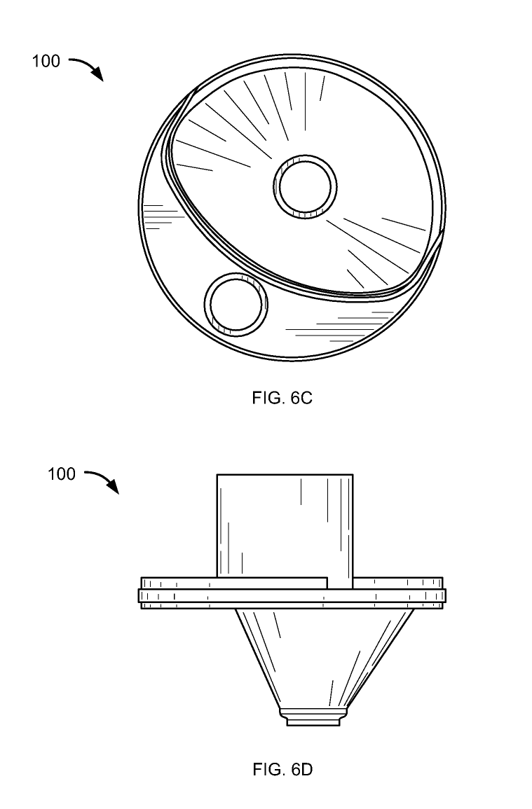

FIGS. 6A-6D illustrate additional detail of optional details and/or features for the liquid quality device 100, according to certain inventive techniques. FIG. 6A illustrates a perspective view of the liquid quality device 100. FIG. 6B depicts an exploded view of the device 100. FIG. 6C shows a top view of the device. FIG. 6D illustrates an elevational view of the device 100.

With reference particularly to FIG. 6B, it can be seen that the base 110 may have a groove sized and shaped to receive the weir 120. The grove may allow for proper and consistent placement of the weir 120 and may facilitate the weir 120 to be attached to the base 110 through welding or fastening. The outer rim of the base 110 may have a staircase profile with two or more levels, whereby the lower level(s) have larger radiuses than the higher level(s). This design may allow for convenient modifications for treatment flow rates by providing guides for different aperture sizes. Each of the sump inlet aperture 112 and/or sump outlet aperture 114 may also have a staircase profile with two or more levels, whereby a lower level of a given aperture may be narrower than an upper level. This allows for simple modifications for treatment flow rates by providing guides for different aperture sizes. The sump inlet aperture 112 also may have a flute (see FIG. 6D for a fuller profile of the flute) that extends downwardly from the vortex-inducing region of the base 110.

Exemplary dimensions of the liquid quality device 100 are as follows. The base 110 may have an outer diameter of approximately 47″. The weir 120 may have a height of approximately 16″. The widest diameter of the funnel along the longest horizontal axis may be approximately 34.39″. The height of the vortex-inducing region may be approximately 23.25″. The groove may be approximately 2″ deep.

The smallest level of the staircase profile in the sump inlet aperture 112 may be approximately 8″ in diameter. The widest aperture of the sump inlet aperture 112 may be approximately 10″ in diameter. Similarly, the smallest level of the staircase profile in the sump outlet aperture 114 may be approximately 8″ in diameter, while the widest may be approximately 10″ in diameter. It may be possible to choose which size apertures 112, 114 are to be used on site or in a factory or facility. For example, narrow apertures (e.g., 8″ apertures) may be used for relatively lower flow applications (e.g., 0.6 cubic feet per second). Optionally, the narrower levels (e.g., 8″ apertures) the may be removed, thereby leaving a wider levels (e.g., 10″ apertures). The wider apertures may be used for relatively higher flow applications (e.g., 1.0 cubic feet per second). The narrower level(s) may be removed with a knife or saw, thereby leaving the wider level(s).

The liquid quality device 100 may not have different levels. It may be manufactured to have different dimensions (e.g., different aperture 112, 114 sizes) in accordance with the principles discussed above.

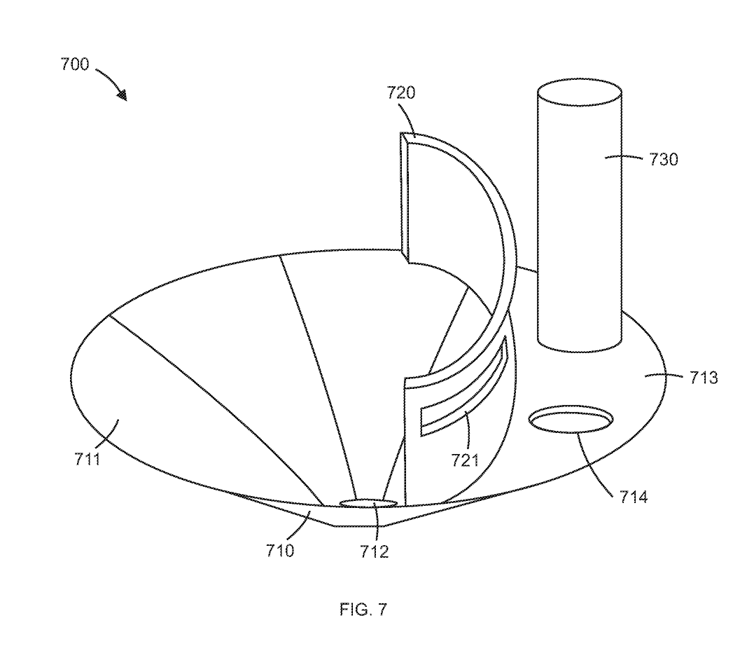

FIG. 7 illustrates a liquid quality device 700 with an alternative design and/or optional features, according to certain inventive techniques. Similar to the one described above, the liquid quality device includes a base 710 and a weir 720. The base 710 may have a first region 711 and a second region 713, which may be separated by the weir 720. The weir 720 may completely (or partially) separate the first region 711 from the second region 713. The first region 711 may include a vortex-inducing region and a sump inlet aperture 712. A vortex-inducing region may include a funnel shape as depicted in FIG. 7. The second region 713 may include a sump outlet aperture 714. The second region 713 may have a generally flat profile in the horizontal dimension.

The liquid quality device 700 may also include a clean-out riser 730 that extends upwardly from an additional aperture (not visible in the figure because it is underneath the riser 730, but may be termed a sump access aperture) in the second region 713. A vacuum may be applied to the clean-out riser 730 to remove accumulated particulates from the sump.

The weir 720 may also have an aperture 721 (e.g., having a rectangular shape). The aperture size and location may be selected to allow an increased flow rate that falls between the design treatment rate and ultimate flow rate (approximately 3× the treatment flow rate) to pass through the aperture 721 without overtopping the entire weir 720. The design treatment rate may be the flow rate of liquid that is intended to pass through the unit and receive treatment for the removal of particulates. The ultimate flow rate may be the total flow rate of the liquid that can pass through the unit (rate that receives treatment and rate that overtops the weir combined) without overflowing from the tubular structure. By not overtopping the weir 720, this may assist in containment of large debris and force it into the sump.

As the flow rates in the liquid quality device 700 approach the ultimate flow rate (again, approximately 3× the treatment flow rate) the additional liquid volume will overtop the weir 720 and exit the device 700. As this point the influent is typically considered to have substantially reduced levels of particulates, and therefore in no need for treatment. By allowing the flows to overtop the weir 720, this also helps reduce velocities in the sump which in turn helps to reduce the re-suspension of the previously collected particulates.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. An apparatus for inducing a vortex in a liquid flow to remove particulates from the liquid, wherein the apparatus is configured for insertion into a tubular portion such that a sump region is located below the apparatus, wherein the apparatus comprises:
a base including:
a first region comprising a funnel shape with a sump inlet aperture; and
a second region comprising a sump outlet aperture; and
a weir extending upwardly from the base and separating the first region from the second region.

2. The apparatus of claim 1, wherein:
the weir comprises a curvature along a horizontal dimension; and
the curvature is concave when viewed from the first region of the base.

3. The apparatus of claim 1, wherein the weir comprises an aperture.

4. The apparatus of claim 3, wherein the aperture in the weir comprises a rectangular shape.

5. The apparatus of claim 1, further comprising a sump access aperture in the second region of the base.

6. The apparatus of claim 5, further comprising a clean out riser extending upwardly from the sump access aperture.

7. The apparatus of claim 1, wherein the base comprises one integrated piece.

8. The apparatus of claim 7, wherein the base comprises polyethylene.

9. The apparatus of claim 7, wherein the weir and the base are separate pieces.

10. The apparatus of claim 9, wherein the base comprises a groove arranged to accept the weir.

11. The apparatus of claim 1, wherein the weir completely separates the first region from the second region.

12. An apparatus for inducing a vortex in a liquid flow to remove particulates from the liquid, wherein the apparatus comprises:
a bottom plate;
a tubular portion extending upwardly from the bottom plate, wherein the tubular portion comprises an inlet and an outlet;
a liquid quality device above the bottom plate, extending horizontally across the tubular portion, and defining a sump region between the liquid quality device and the bottom plate, wherein the liquid quality device includes:
a base including:
a first region comprising a funnel shape and a sump inlet aperture, wherein the first region is arranged to receive a flow of the liquid from the inlet of the tubular portion; and
a second region comprising a sump outlet aperture, wherein the second region is arranged to transfer a flow of the liquid to the outlet of the tubular portion; and
a weir extending upwardly from the base and separating the first region from the second region.

13. The apparatus of claim 12, wherein:
the weir comprises a curvature along a horizontal dimension; and
the curvature is concave when viewed from the first region of the base.

14. The apparatus of claim 12, wherein the weir comprises an aperture.

15. The apparatus of claim 14, wherein the aperture in the weir comprises a rectangular shape.

16. The apparatus of claim 12, further comprising a sump access aperture in the second region of the base.

17. The apparatus of claim 16, further comprising a clean out riser extending upwardly from the sump access aperture.

18. The apparatus of claim 12, wherein the base comprises one integrated piece.

19. The apparatus of claim 18, wherein the base comprises polyethylene.

20. The apparatus of claim 18, wherein the weir and the base are separate pieces.

21. The apparatus of claim 20, wherein the base comprises a groove arranged to accept the weir.

22. The apparatus of claim 12, wherein the weir completely separates the first region from the second region.

23. The apparatus of claim 12, wherein the inlet and the outlet of the tubular portion comprise an inline arrangement.

24. The apparatus of claim 12, wherein the inlet and the outlet of the tubular portion comprise an offline arrangement.
